(19) United States
(12) Patent Application Publication
(10) Pub. No.: US 2024/0280382 A1
(43) Pub. Date: Aug. 22, 2024

(54) COIL AREA REDUCTION FOR SIGNAL OFFSET COMPENSATION IN A LINEAR INDUCTIVE POSITION SENSOR

(71) Applicant: Microchip Technology Incorporated, Chandler, AZ (US)

(72) Inventors: Ganesh Shaga, Warangal (IN); Surendra Akkina, Hyderabad (IN); Sudheer Puttapudi, Hyderabad (IN)

(21) Appl. No.: 18/443,804

(22) Filed: Feb. 16, 2024

(30) Foreign Application Priority Data
Feb. 17, 2023 (IN) 202341010768

(51) Int. Cl. G01D 5/20

(52) U.S. Cl. CPC G01D 5/20

(57) ABSTRACT

An apparatus comprises a support structure; a first sense coil comprising a sine coil arranged about a longitudinal axis of the support structure, the sine coil having opposing ends between opposing ends of the support structure, the sine coil defining at least a first lobe and a second lobe; a second sense coil comprising a cosine coil arranged about the longitudinal axis of the support structure, the cosine coil having opposing ends between the opposing ends of the support structure, the cosine coil defining first lobe portions coextensive with the first lobe of the sine coil and second lobe portions coextensive with the second lobe of the sine coil; and one or more oscillator coils arranged around the sine and the cosine coils. A coil area of the first lobe of the sine coil is less than a coil area of the first lobe portions of the cosine coil.

### PRIORITY CLAIM

This application claims the benefit of the filing date of Republic of India Provisional Patent Application Ser. No. 202341010768, filed Feb. 17, 2023, for “Linear Inductive Position Sensor With Increased Measurement Range,” the disclosure of which is hereby incorporated herein in its entirety by this reference.

### TECHNICAL FIELD

This disclosure relates generally to linear inductive position sensing. More specifically, some examples relate to non-contacting planar linear inductive position sensors for measuring the position of a movable target, without limitation. Additionally, apparatuses and methods are disclosed.

### BACKGROUND

If a coil of wire is placed in a changing magnetic field, a voltage will be induced at ends of the coil of wire. In a predictably changing magnetic field, the induced voltage will be predictable (based on factors including the area of the coil affected by the magnetic field and the degree of change of the magnetic field). It is possible to disturb a predictably changing magnetic field and measure a resulting change in the voltage induced in the coil of wire. Further, it is possible to create a sensor that measures movement of a disturber of a predictably changing magnetic field based on a change in a voltage induced in a coil of wire.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1A is a top-down view of an apparatus comprising a linear inductive position sensor for position sensing of a target according to one or more examples, the apparatus comprising a support structure, one or more oscillator coils, a first sense coil comprising a sine coil, and a second sense coil comprising a cosine coil, where the target is shown positioned in a start position;

FIG. 1B is a top-down view of the apparatus comprising the linear inductive position sensor for position sensing of the target according to one or more examples, where the target is shown positioned in an end position;

FIG. 2 is a top-down view of the apparatus of FIGS. 1A and 1B without the target;

FIG. 3A is a top-down view of the apparatus of FIG. 2, illustrating the one or more oscillator coils without the sine and cosine coils, according to one or more examples;

FIG. 3B is a top-down view of the apparatus of FIG. 2, illustrating the first sense coil comprising the sine coil without the one or more oscillator coils and the cosine coil, according to one or more examples;

FIG. 3C is a top-down view of the apparatus of FIG. 2, illustrating the second sense coil comprising the cosine coil without the one or more oscillator coils and the sine coil, according to one or more examples;

FIG. 4 is a close-up view of the first lobe of the sine coil of FIGS. 2 and 3B, according to one or more examples;

FIGS. 5A and 5B are top-down views of the apparatus with the target, and including indications for explaining the behavior of operation, according to one or more examples;

FIGS. 6A and 6B are illustrative representations of the apparatus comprising the linear inductive position sensor as used in a specific application, namely, a clutch application, according to one or more examples;

FIG. 7 is a top-down view of an apparatus comprising a linear inductive position sensor for position sensing of a target, according to one or more examples;

FIG. 8A is a schematic diagram of a position sensor circuitry for the apparatus, according to one or more examples;

FIG. 8B is a flowchart for describing a method of operating an apparatus comprising a linear inductive position sensor according to one or more examples;

FIG. 9 is a graph of output voltages of the sine and cosine coils versus target position for a linear inductive position sensor, without use of the optimization of the disclosure;

FIG. 10 is a graph of analog output voltage versus target position for a linear inductive position sensor, without use of the optimization of the disclosure;

FIG. 11 is a graph of output voltages of the sine and cosine coils versus target position for a linear inductive position sensor, according to one or more examples of the disclosure;

FIG. 12 is a graph of analog output voltage versus target position for a linear inductive position sensor, according to one or more examples of the disclosure;

FIGS. 13A and 13B are top-down views of sine and cosine coils, respectively, of a linear inductive position sensor according to one or more examples;

FIGS. 14A and 14B are top-down views of sine and cosine coils, respectively, of a linear inductive position sensor according to one or more examples; and

FIG. 15 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

The inventors of this disclosure appreciate that there is demand for position sensors that are light-weight, low-cost, reliable, and have increased noise immunity. For example, a trend of today is toward autonomous cars that utilize artificial intelligence (AI) technology that benefits from information captured via a position sensor. One option is inductive position sensors.

Inductive position sensors, including linear inductive position sensors, are useful. There are many advantages to inductive sensing technology, such as: contactless sensing; sensing in harsh environments; resistance to extraneous magnetic fields; immunity to electromagnetic interference (EMI)/electromagnetic compatibility (EMC); ease of design on a printed circuit board (PCB) using a metallic object as a target; ease of customization; and cost-effectiveness, without limitation.

Typical position sensors used in the automotive industry are not configured for clutch applications in motor or automotive vehicles, in which an area of a target (or movable or sliding part) increases over a measurement range of the sensor. Using a typical position sensor design, the measurement range of the position sensor will be limited and have poor accuracy.

The present disclosure generally relates to a non-contacting planar linear inductive sensor for measuring the position of a movable target relative to a stationary sensor or for measuring the position of a movable sensor relative to a stationary target. The disclosed linear inductive position sensors may be utilized in a variety of operational contexts, such as for clutch applications in motor or automotive vehicles, or linear actuation applications, without limitation. As will be described, position sensors configured in accordance with various examples described herein may exhibit one or more of increased linearity, measurement range, mechanical resolution, and/or accuracy.

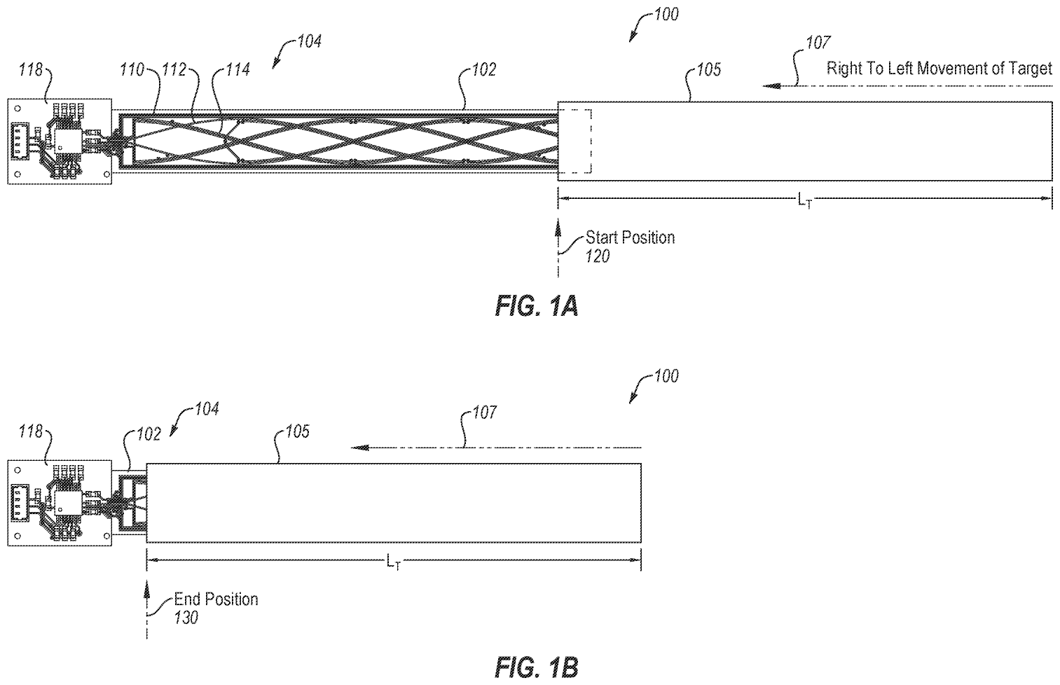

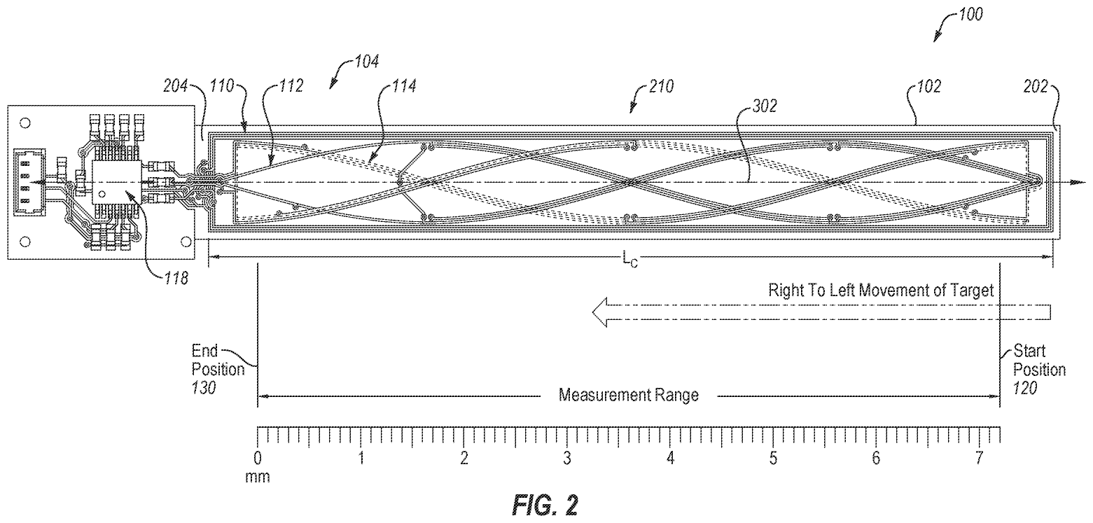

FIGS. 1A and 1B are top-down views of an apparatus 100 comprising a linear inductive position sensor for position sensing of a target 105, according to one or more examples of the disclosure. FIG. 2 is a top-down view of apparatus 100 of FIGS. 1A and 1B without the target.

Apparatus 100 comprises a support structure 102 and multiple coils 104 on, or in, support structure 102. Multiple coils 104 include one or more oscillator coils 110, a first sense coil comprising a sine coil 112, and a second sense coil comprising a cosine coil 114. One or more oscillator coils 110 (or excitation coils) may be referred to as one or more primary coils, and sine and cosine coils 112 and 114 may be referred to as secondary coils.

Multiple coils 104 may be laid out as conductive traces on, or in, one or more planes or layers of support structure 102. In one or more examples, support structure 102 is or includes a substrate, such as a PCB. In one or more further examples, support structure 102 is or includes at least a two-layered PCB including conductive traces to form the coils. An example layering is illustrated in FIG. 2, where solid coil lines on support structure 102 represent conductive traces on a first layer (e.g., a top layer) of the PCB and dashed coil lines on support structure 102 represent conductive traces on a second layer (e.g., a bottom layer) of the PCB. The small circles on support structure 102 are conductive vias to connect the conductive traces to and from the different layers.

With reference to FIGS. 1A and 1B, target 105 may have a target body which is generally planar (i.e., in-plane with the page). Target 105 is movably positionable along a longitudinal axis of support structure 102 from a start position 120 to an end position 130. In FIG. 1A, target 105 is shown positioned in start position 120 at a first end (e.g., a right or rightmost end) of support structure 102. In one or more examples, target 105 is movably positioned along the longitudinal axis in a direction 107 (e.g., right-to-left movement) towards a second (opposing) end (e.g., a left or left-most end) of support structure 102. In FIG. 1B, target 105 is shown positioned in end position 130 at the second end of support structure 102.

In FIG. 2, first and second ends 202 and 204 of support structure 102 are designated, including first end 202 at which start position 120 is generally indicated and second end 204 at which end position 130 is generally indicated. A longitudinal axis 302 of support structure 102 along which the target is movably positionable is also indicated.

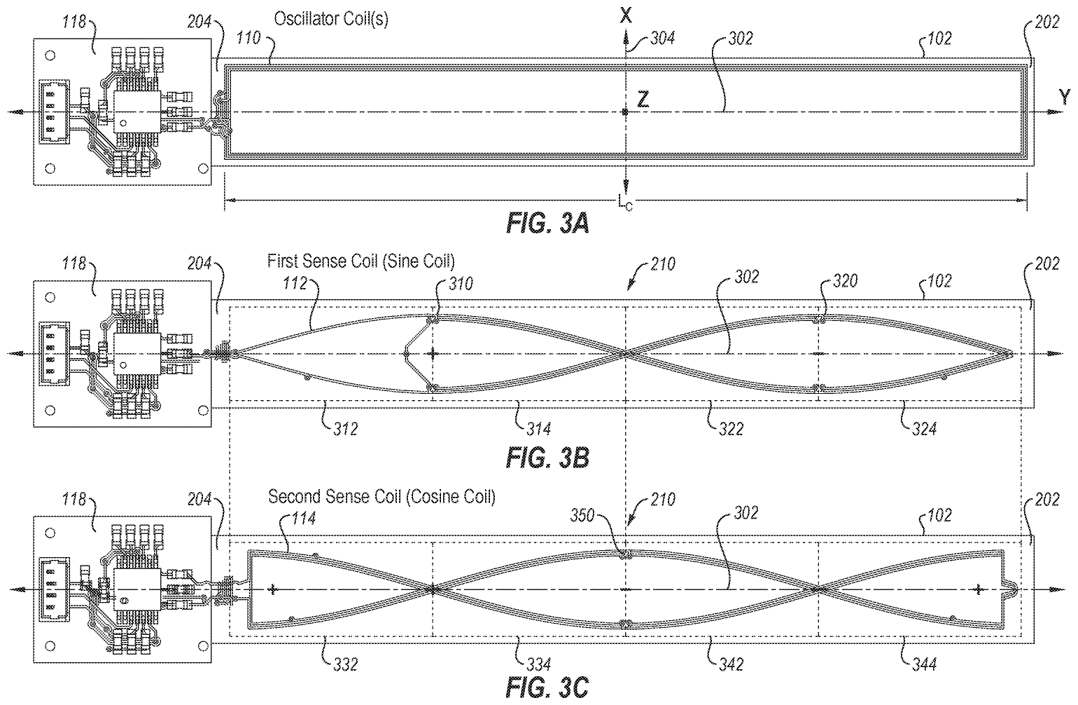

FIGS. 3A-3C are top-down views of the apparatus of FIG. 2, each figure illustrating a respective one of the sensor coils with the other coils removed. More particularly, FIG. 3A is a top-down view of the apparatus of FIG. 2, illustrating one or more oscillator coils 110 without the sine and cosine coils. FIG. 3B is a top-down view of the apparatus of FIG. 2, illustrating the first sense coil comprising sine coil 112 without the one or more oscillator coils and the cosine coil. FIG. 3C is a top-down view of the apparatus of FIG. 2, illustrating the second sense coil comprising cosine coil 114 without the one or more oscillator coils and the sine coil.

With reference to FIG. 3A, one or more oscillator coils 110 are shown to form a generally rectangular shape. Longitudinal axis 302 of support structure 102 is indicated along the Y-axis of the coordinate system, shown together with a transverse axis 304 of support structure 102 along the X-axis, and with the Z-axis extending perpendicularly out of the plane of the page. With reference to FIG. 3B, the first sense coil comprising sine coil 112 is arranged about longitudinal axis 302 of support structure 102, and has opposing ends between opposing ends (e.g., first and second ends 202 and 204) of the support structure 102. With reference to FIG. 3C, the second sense coil comprising cosine coil 114 is also arranged about longitudinal axis 302 of support structure 102, and has opposing ends between the opposing ends of support structure 102 (e.g., first and second ends 202 and 204). With reference to FIGS. 2 and 3A, one or more oscillator coils 110 are arranged around the sine and the cosine coils.

In FIG. 3B, sine coil 112 generally forms a sine wave pattern and defines at least a first lobe 310 (e.g., a positive lobe) and a second lobe 320 (e.g., a negative lobe). First lobe 310 of sine coil 112 may comprise first lobe portions 312 and 314 (e.g., first and second half lobes, respectively), and second lobe 320 of sine coil 112 may comprise second lobe portions 322 and 324 (e.g., also first and second half lobes, respectively). First lobe portion 312 and second lobe portion 324 may be referred to as end-side lobe portions (which are toward first and second ends 202 and 204, respectively), whereas first lobe portion 314 and second lobe portion 322 may be referred to as middle-side lobe portions (which are toward a middle 210 of support structure 102).

In FIG. 3C, cosine coil 114 generally forms a cosine wave pattern and defines first lobe portions 332 and 334 substantially coextensive with first lobe 310 of sine coil 112, and second lobe portions 342 and 344 substantially coextensive with second lobe 320 of sine coil 112. At the middle 210 of support structure 102, cosine coil 114 defines a lobe 350 (e.g., a negative lobe) from first lobe portion 334 (e.g., a first half lobe) and second lobe portion 342 (e.g., a second half lobe).

More particularly, sine coil 112 of FIG. 3B may be defined by one or more first segments having the shape of a sine function, sin x, over a 360° Cycle starting at 0° (e.g., in a forward path), and one or more second segments having the shape of another sine function, −sin x, over a 360° Cycle starting at 0° (e.g., in a return path). Second ends of the one or more first and second segments of sine coil 112 are electrically connected to each other substantially at or near first end 202 of support structure 102 at longitudinal axis 302 (for the return path), and first ends of the one or more first and the second segments of sine coil 112 may be electrically connected to each other substantially at or near second end 204 of support structure 102 at longitudinal axis 302 for respective ones of one or more turns of the sine coil. Cosine coil 114 of FIG. 3C may be defined by one or more first segments having the shape of a cosine function, cos x, over a 360° Cycle starting at 0° (e.g., in a forward path), and one or more second segments having the shape of another cosine function, −cos x, over a 360° Cycle starting at 0° (e.g., in a return path). Second ends of the one or more first and second segments of cosine coil 114 are electrically connected to each other substantially at or near second end 204 of support structure 102 (for the return path), and first ends of the one or more first and second segments of cosine coil 114 may be electrically connected to each other substantially at or near second end 204 of support structure 102 for respective ones of one or more turns of the cosine coil.

Apparatus 100 may also include a position sensor circuitry 118 to process signals associated with the multiple coils 104 for sensing a position of target 105. In one or more examples, position sensor circuitry 118 may be provided in an integrated circuit (IC).

In operation, with reference to FIGS. 1A, 1B, 2, and 3A-3C, one or more oscillator coils 110 are excited with a relatively high frequency signal (e.g., 5 MHz, without limitation) from position sensor circuitry 118 to generate a varying magnetic field. The magnetic fields couple onto sine and cosine coils 112 and 114 to produce first and second sense signals, respectively. The first and the second sense signals may be cosine and sine signals, which may be generally close to ideal cosine and sine waveforms. Thus, the coupled signals may be phase-shifted by 90 degrees, where sine coil 112 exhibits a cosine profile and cosine coil 114 exhibits a sine profile. Sine coil 112 is referred to herein using the term “sine” and cosine coil 114 is referred to herein using the term “cosine” to differentiate between the respective sense coils, and because of the physical coil waveform appearance of the respective sense coils on, or in, support structure 102. However, alternative terminology may be utilized, where sine coil 112 is instead referred to using the term “cosine” and cosine coil 114 is instead referred to using the term “sine,” because of the resulting waveforms produced in the respective sense coils.

Meanwhile, target 105 (e.g., a metal target) may be positioned over multiple coils 104 of inductive position sensor 100, and set at a generally fixed distance (i.e., along the Z-axis of the coordinate system in FIG. 3A) from the multiple coils referred to as an airgap. Target 105 will disturb the generated magnetic field. When target 105 is moved, it creates modulated sine and cosine waveforms which are received at the position sensor circuitry 118. The modulated sine and cosine signals may be de-modulated for generating first and second voltage position signals associated with the position of target 105. When a processor is included in the IC, the first and second voltage position signals may be used to calculate the position of target 105, for example, by taking an arctan2 function of the ratio of the signals.

Target 105 may be made of a conductive material, such as a non-magnetic conductive metal or metal alloy, without limitation. In one or more examples, the non-magnetic conductive metal or metal alloy may be or include copper or aluminum. In one or more other examples, target 105 may be made of a magnetic conductive metal or metal alloy, such as carbon steel or ferritic stainless steel, without limitation. Here, an oscillator or excitation circuitry may generate an excitation signal within a certain range of frequencies (e.g., 1-6 MHz, without limitation) that magnetic domains of the magnetic conductive metals or metal alloys will not react to.

In many applications, the target has a relatively short length which is substantially less than the measurement range that extends between the opposing ends of the sine or cosine coil. As a result, the target has an area for magnetic field disturbance that remains the same as it is movably positioned across the measurement range of the sensor. In one or more examples of FIGS. 1A, 1B and 2, target 105 has a length L_{T} that is greater than or equal to a measurement range of the sensor, which extends generally from start position 120 to end position 130 of the sensor. In one or more examples, target 105 has a length L_{T} that is greater than or equal to the coil length L_{C}, or greater than or equal to at least 90 percent of the coil length L_{C}. The measurement range may extend substantially between the opposing ends of sine coil 112 or cosine coil 114 over a coil length L_{C} (FIG. 2), or over at least 90 percent of the coil length L_{C}. In FIG. 2, it is shown that the measurement range of apparatus 100 may be about 72 millimeters (mm), without limitation.

Given the above, target 105 has an area for magnetic field disturbance that increases as it is movably positioned across the measurement range of the sensor. For example, in start position 120, target 105 may disturb substantially little or none of a magnetic coupling between one or more oscillator coils 110 and sine and cosine coils 112 and 114. In the middle 210 of the measurement range, target 105 may disturb substantially an entire half of the magnetic coupling between one or more oscillator coils 110 and sine and cosine coils 112 and 114. In end position 130, target 105 may disturb substantially most or an entirety of the magnetic coupling between one or more oscillator coils 110 and sine and cosine coils 112 and 114.

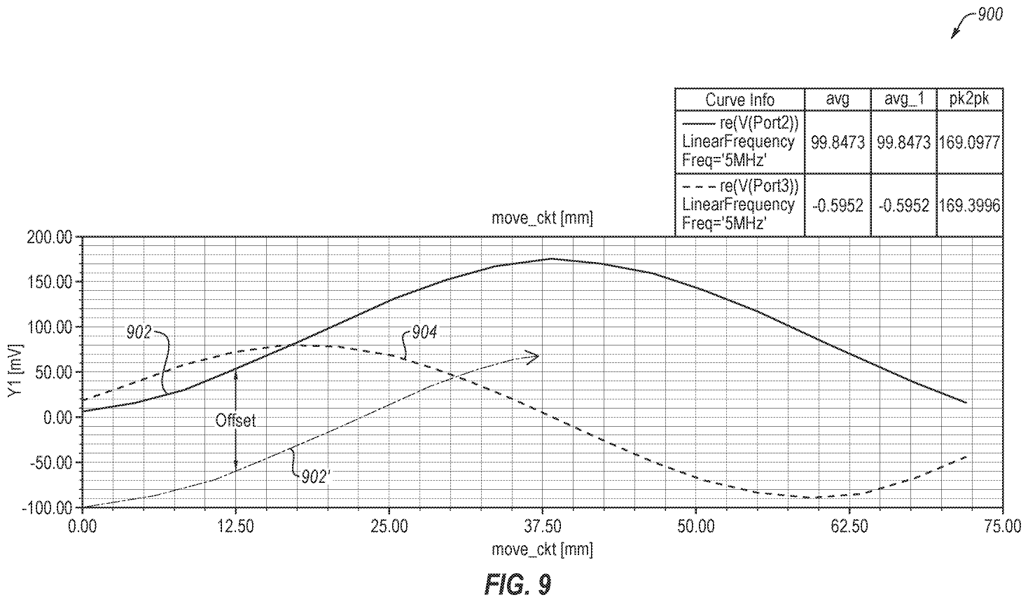

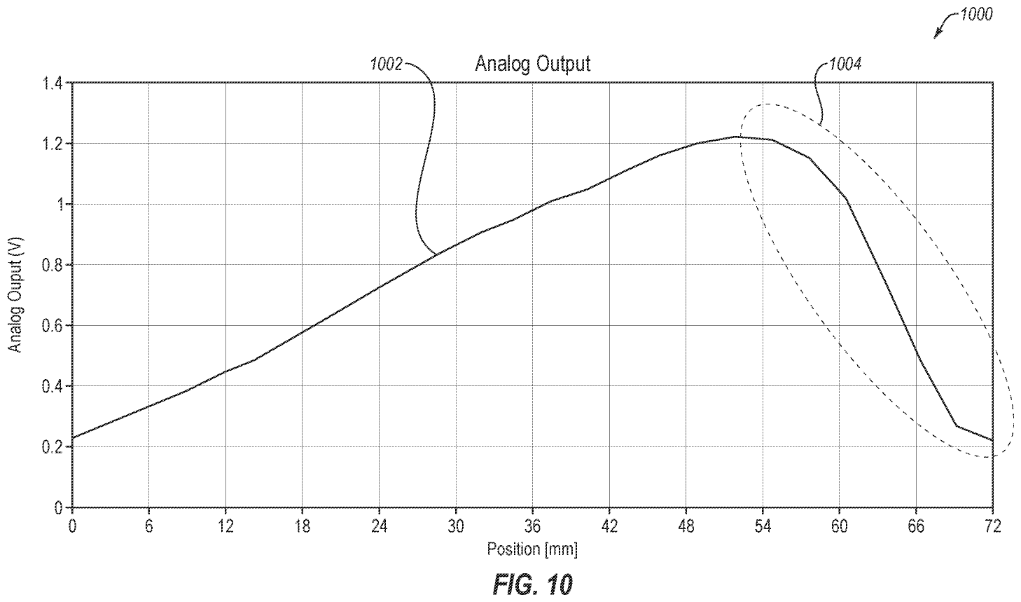

Given the length L_{T} of target 105, and therefore its increasing area across the measurement range during travel, an offset voltage (e.g., DC offset) is exhibited in the position signal. As a result, without using any optimization the measurement range of the sensor will be limited and have poor accuracy. The signal offset and its resulting effect are shown and described later in more detail in relation to FIGS. 9 and 10.

According to one or more examples of the disclosure, a coil area of first lobe 310 of sine coil 112 is reduced to compensate for the signal offset. Reduction of the coil area of first lobe 310 of sine coil 112 may be referred to herein as lobe area reduction. In one or more examples, first lobe 310 having the reduced coil area is located at second end 204 of support structure 102 at or towards end position 130 for target 105 (e.g., towards the coupling of multiple coils 104 to position sensor circuitry 118).

More particularly, in one or more examples, a coil area of first lobe 310 of sine coil 112 is less than a coil area of first lobe portions 332 and 334 of cosine coil 114. In one or more examples, the coil area of first lobe 310 of sine coil 112 is less than the coil area of first lobe portions 332 and 334 of cosine coil 114 by a percentage difference, where the percentage difference of first lobe 310 is sufficient to cancel or compensate for the signal offset.

In one or more examples, the percentage difference is within a range of about 20 to 30 percent, without limitation. In one or more examples, the coil area of first lobe 310 of sine coil 112 is less than the coil area of first lobe portions 332 and 334 of cosine coil 114 by about 25 percent, without limitation.

As is apparent, the coil area reduction of first lobe 310 of sine coil 112 may be observed relative to the coil area of first lobe portions 312 and 314 of cosine coil 114. On the other hand, the coil area reduction of first lobe 310 of sine coil 112 may be additionally or alternatively observed relative to the coil area of second lobe 320 of sine coil 112, in a configuration where the coil area of respective lobes and/or lobe regions other than first lobe 310 of sine coil 112 (all) remain the same.

Lobe area reduction for signal offset compensation may be achieved in a number of different ways. In one or more examples, lobe area reduction for signal offset compensation may be achieved by reducing the number of coil winding portions of first lobe 310 of sine coil 112. Here, the reduced number of coil winding portions of first lobe 310 of sine coil 112 may be observed relative to the number of coil winding portions of first lobe portions 332 and 334 of cosine coil 114. On the other hand, the reduced number of coil winding portions of first lobe 310 of sine coil 112 may be additionally or alternatively observed relative to the number of coil winding portions of second lobe 320 of sine coil 112, in a configuration where the number of coil winding portions of respective lobes and/or lobe regions other than first lobe 310 of sine coil 112 (all) remain the same.

Accordingly, in one or more examples, first lobe 310 of sine coil 112 comprises a first number of one or more first coil winding portions, and first lobe portions 332 and 334 of cosine coil 114 comprise a second number of one or more second coil winding portions, where the first number of the one or more first coil winding portions is less than the second number of the one or more second coil winding portions. The reduction in the number of coil winding portions may be sufficient to cancel or compensate for the signal offset.

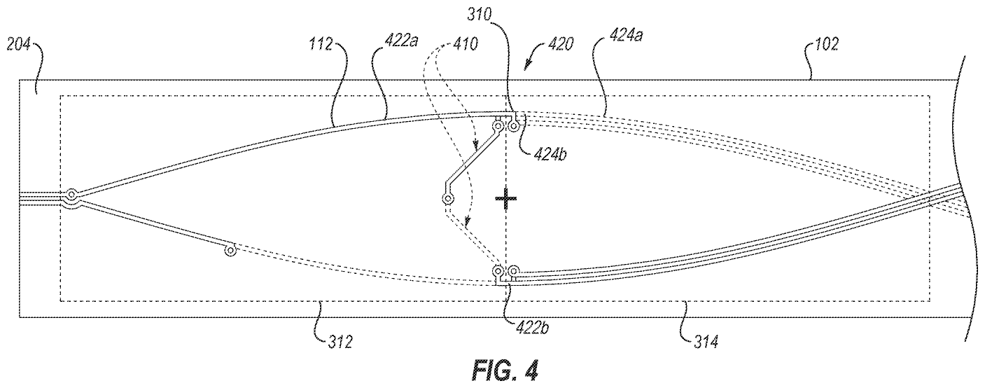

FIG. 4 is a close-up view of first lobe 310 of sine coil 112 of FIGS. 2 and 3B, according to one or more examples. Here, lobe area reduction for signal offset compensation is achieved by reducing the number of coil winding portions of first lobe 310 of sine coil 112 (e.g., where the coils are configured with more than one coil turn).

As shown in FIG. 4, first lobe 310 of sine coil 112 has a first number of one or more first coil winding portions, namely, six (6) coil winding portions: two (2) coil winding portions on first lobe portion 312 (one on the top, and one on the bottom), and four (4) coil winding portions on first lobe portion 314 (two on the top, and two on the bottom). On the other hand, in FIG. 3C, first lobe portions 332 and 334 of cosine coil 114 have a second number of one or more second coil winding portions, namely, eight (8) coil winding portions: four (4) coil winding portions on first lobe portion 332 (two on the top, and two on the bottom), and four (4) coil winding portions on first lobe portion 334 (two on the top, and two on the bottom). Similarly in FIG. 3B, second lobe portions 322 and 324 of second lobe 320 of sine coil 112 also have the second number of one or more second coil winding portions, namely, eight (8) coil winding portions: four (4) coil winding portions on second lobe portion 322 (two on the top, and two on the bottom), and four (4) coil winding portions on second lobe portion 324 (two on the top, and two on the bottom).

As is apparent in FIG. 4, the first number of the one or more first coil winding portions of first lobe 310 of sine coil 112 is less than the second number of the one or more second coil winding portions on first lobe portions 332 and 334 of cosine coil 114 (FIG. 3C), and/or on second lobe 320 of sine coil 112 (FIG. 3B). The reduction in the number of coil winding portions on first lobe 310 of sine coil 112 may be sufficient to cancel or compensate for the signal offset. In this specific, non-limiting example, the percent lobe area reduction for first lobe 310 of sine coil 112 is: (8 coil winding portions−6 coil winding portions)÷8 total coil winding portions=25 percent reduction.

In one or more examples, the calculation of the percentage reduction of first lobe 310 of sine coil 112 relative to first lobe portions 332 and 334 of cosine coil 114 omits the (substantially non-contributing) coil area of the one or more coil winding portions of first lobe portion 332 of cosine coil 114 on the leftmost side (vertical portions) of first lobe portion 332.

In one or more specific examples, the lobe area reduction is achieved by reducing only the coil area of the first half lobe (e.g., first lobe portion 312) of first lobe 310 of sine coil 112, and not the second half lobe (e.g., first lobe portion 314) of sine coil 112. More specifically with respect to FIGS. 3B and 3C, first lobe 310 of sine coil 112 includes a first half lobe (e.g., first lobe portion 312) and a second half lobe (e.g., first lobe portion 314). The coil area of first lobe 310 of sine coil 112 is defined by a first coil area of the first half lobe and a second coil area of the second half lobe. The first lobe portions 332 and 334 of cosine coil 114 include a first half lobe (e.g., first lobe portion 332) substantially coextensive with first half lobe (e.g., first lobe portion 312) of sine coil 112, and a second half lobe (e.g., first lobe portion 334) substantially coextensive with the second half lobe (e.g., first lobe portion 314) of sine coil 112. The coil area of first lobe portions 332 and 334 of the cosine coil 114 is defined by a first coil area of the first half lobe (e.g., first lobe portion 332) and a second coil area of the second half lobe (e.g., first lobe portion 334). In one or more examples, the first coil area of the first half lobe of sine coil 112 is less than the first coil area of the first half lobe of cosine coil 114 by a percentage difference, where the percentage difference is between about 40 and 60 percent (e.g., about 50 percent). The second coil area of the second half lobe of sine coil 112 is substantially the same as the second coil area of the second half lobe of cosine coil 114. The coil area reduction on the first half lobe (only) of sine coil 112 results in a reduced coil area of first lobe 310 of sine coil 112 (e.g., about 25 percent).

In a specific, non-limiting example of FIG. 4, a bypass connection is utilized in sine coil 112 to achieve the reduced number of coil winding portions. In one or more examples, sine coil 112 having first lobe 310 comprises at least a first coil turn 422a, a second coil turn 424a, and a bypass connection 410. Bypass connection 410 is to connect an end 422b of first coil turn 422a to a beginning 424b of second coil turn 424a at substantially a middle 420 of first lobe 310. As a result of using bypass connection 410, first lobe 310 of sine coil 112 excludes an end portion (not shown, since excluded) of first coil turn 422a and a beginning portion (not shown, since excluded) of second coil turn 424a on the first half lobe (e.g., first lobe portion 312) of first lobe 310. The exclusion of the end and the beginning portions of the coil turn results in a reduced coil area of first lobe 310 of sine coil 112. In one or more examples, the calculation of the percentage reduction of first lobe 310 of sine coil 112 relative to first lobe portions 332 and 334 of cosine coil 114 omits the (substantially non-contributing) coil area of bypass connection 410.

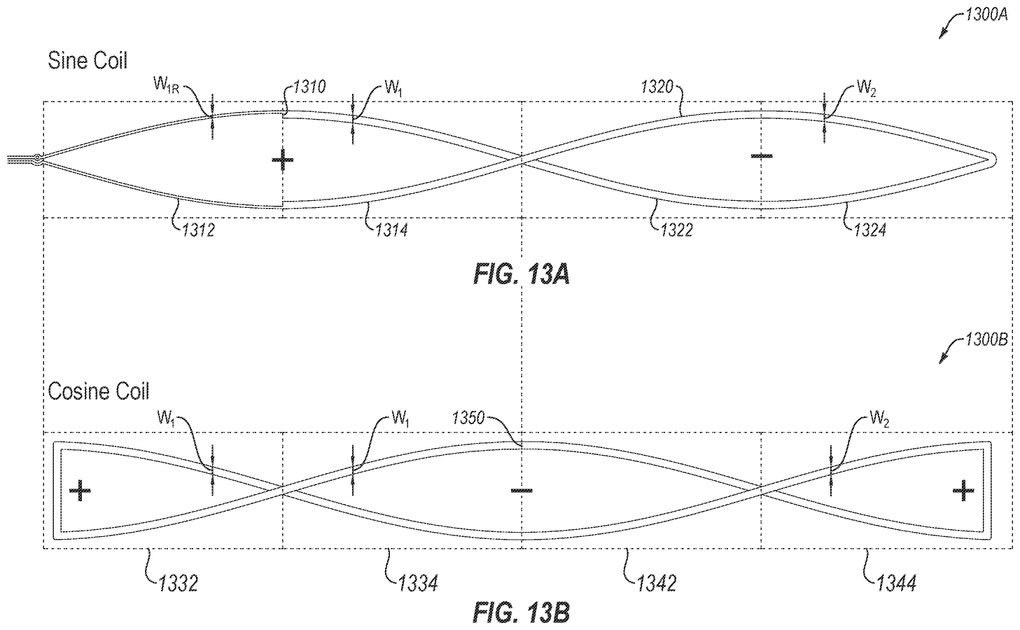

In one or more other examples, lobe area reduction for signal offset compensation may be achieved by reducing a width of one or more coil winding portions of first lobe 310 of sine coil 112. In one or more examples, a width of one or more first coil winding portions of the first lobe of the sine coil is less than a width of one or more second coil winding portions of the first lobe portions of the cosine coil. Similarly, in one or more examples, a width of one or more first coil winding portions of the first lobe of the sine coil is less than a width of one or more second coil winding portions of the second lobe of the sine coil, in a configuration where the widths of one or more coil winding portions of lobes and/or lobe regions other than the first lobe of the sine coil (all) remain the same. The difference in the width of the one or more first coil winding portions may be sufficient to cancel or compensate for the signal offset. One or more examples of lobe area reduction by reducing a width of one or more coil winding portions are shown and described later in relation to FIGS. 13A and 13B.

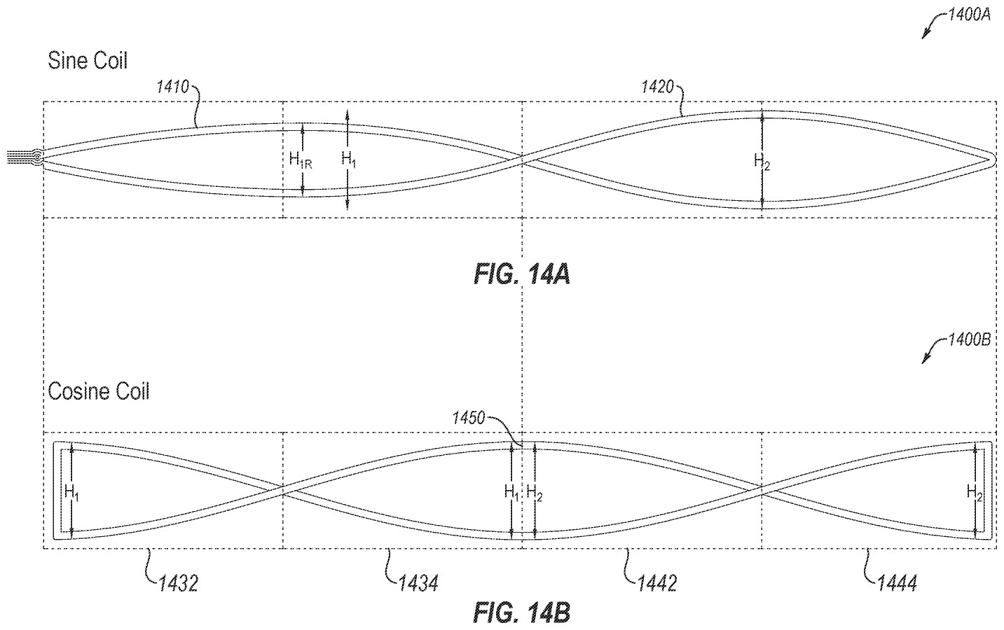

In one or more other examples, lobe area reduction for signal offset compensation may be achieved by reducing a maximum height or size of the first lobe of the sine coil. In one or more examples, a maximum height or size of the first lobe of the sine coil is less than a maximum height or size of the first lobe portions of the cosine coil. Similarly, in one or more examples, a maximum height or size of the first lobe of the sine coil is less than a maximum height or size of the second lobe of the sine coil, in a configuration where the maximum heights or sizes of respective lobes and/or lobe regions other than the first lobe of the sine coil (all) remain the same. The difference in the maximum height or size of the first lobe of the sine coil may be sufficient to cancel or compensate for the signal offset. One or more examples of lobe area reduction by reducing a maximum height or size of the first lobe of the sine coil are shown and described later in relation to FIGS. 14A and 14B.

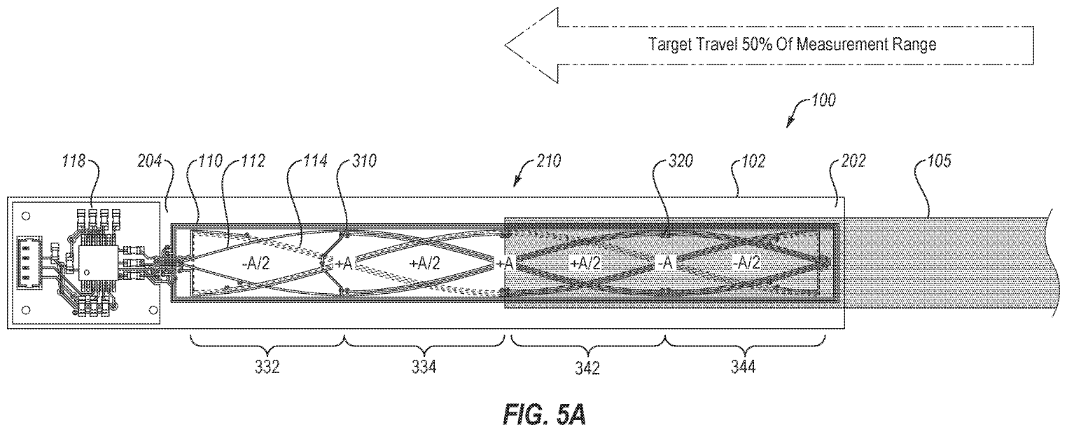

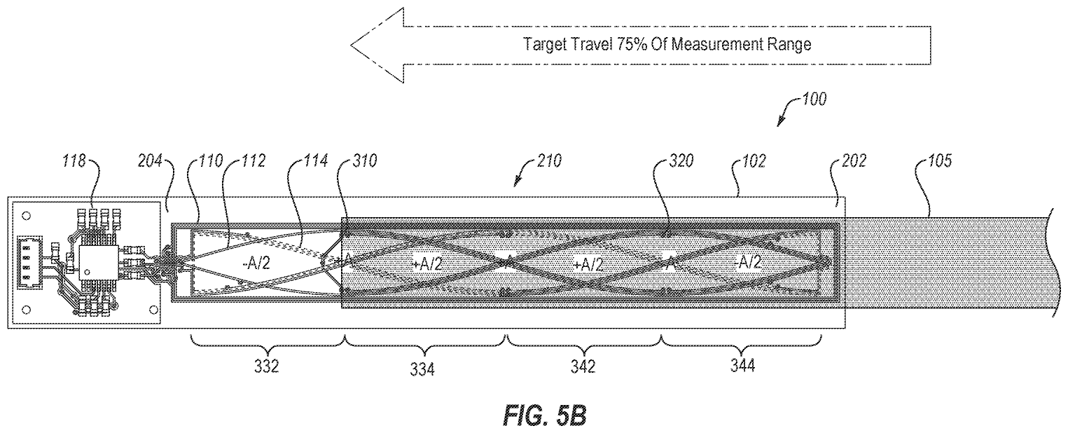

FIGS. 5A and 5B are top-down views of apparatus 100 with target 105, including indications (e.g., coil area indicators) for explaining the behavior of operation, according to one or more examples. With respect to sine coil 112, first lobe 310 of sine coil 112 is associated with +A area and second lobe 320 of sine coil 112 is associated with −A area. With respect to cosine coil 114, first lobe portion 332 of cosine coil 114 is associated with−A/2 area, first lobe portion 334 of cosine coil 114 is associated with +A/2 area, second lobe portion 342 of cosine coil 114 is associated with +A/2 area, and second lobe portion 344 of cosine coil 114 is associated with −A/2 area.

In FIG. 5A, target 105 is shown positioned in a first position (e.g., at middle 210 of support structure 102) to cover about fifty (50) percent of the measurement range of the sensor. When target 105 covers 50 percent of the measurement range, it completely covers the −A area of second lobe 320 of sine coil 112. As a result, what is obtained at the middle position is a peak of the coupled signal. With respect to cosine coil 114, the voltage coupled will be zero (0), as half of the positive area and half of negative area coupled voltages are canceled.

In FIG. 5B, target 105 is shown positioned in a second position to cover about seventy-five (75) percent of the measurement range of the sensor. When target 105 covers 75 percent of the measurement range, what is obtained is 25 percent of the peak signal. The sine signal includes the DC shifted signal. By provided the reduced coil area of the lobe of sine coil 112 (e.g., the 25% reduced area) based on target 105 and/or its movement coverage area, compensation for the DC shift in the coupled secondary signal is realized.

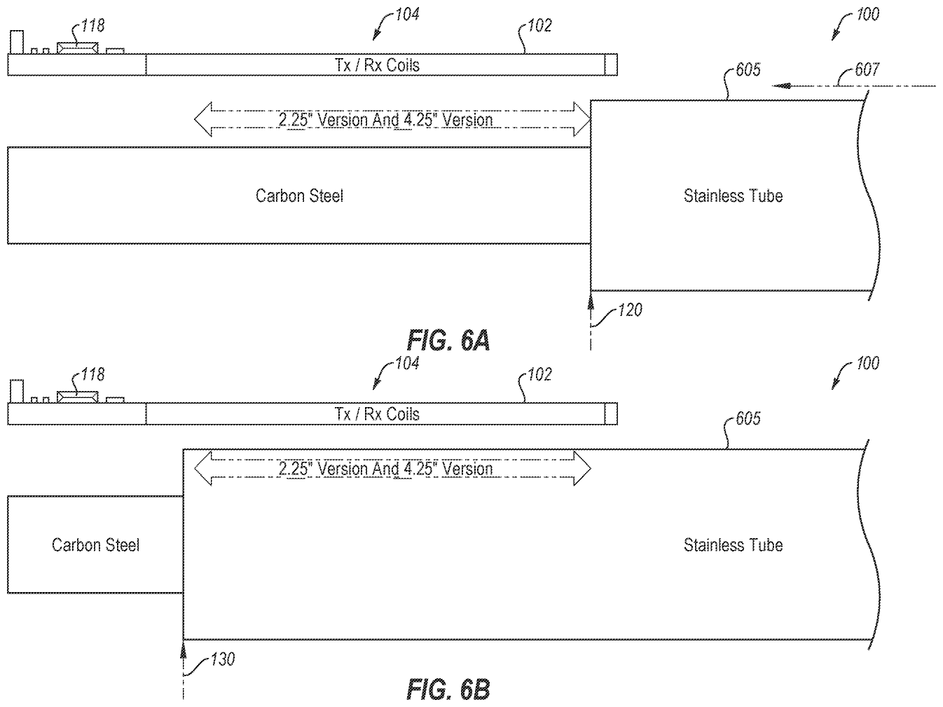

FIGS. 6A and 6B are illustrative representations of apparatus 100 comprising the linear inductive position sensor as used in a specific application, namely, a clutch application, according to one or more examples. A target or movable part 605 (e.g., a stainless steel tube) is movably positionable along a longitudinal axis of support structure 102 from start position 120 to end position 130. In FIG. 6A, movable part 605 is shown positioned in start position 120 at a first end (e.g., a right or rightmost end) of support structure 102. In one or more examples, movable part 605 is movably positioned along the longitudinal axis in a direction 607 (e.g., right-to-left movement) towards a second (opposing) end (e.g., a left or left-most end) of support structure 102, in a gradual covering of (at least a portion of) a carbon steel part. In FIG. 6B, movable part 605 is shown positioned in end position 130 at the second end of support structure 102.

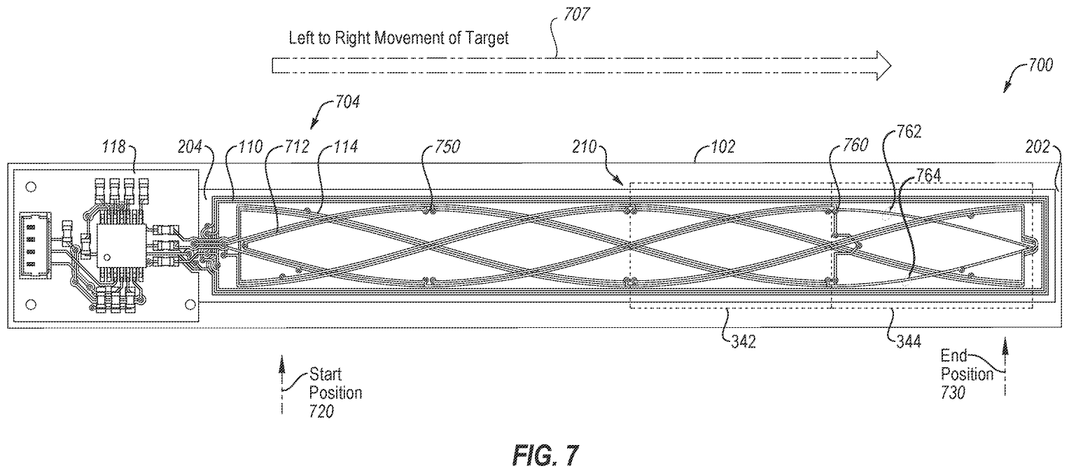

FIG. 7 is a top-down view of an apparatus 700 comprising a linear inductive position sensor for position sensing of a target, according to one or more examples of the disclosure. Apparatus 700 is similar to apparatus 100 of FIGS. 1A, 1B, 2, 3A-3C, and 4, except for the direction of target travel (namely, left to right movement) and the corresponding change to the sine coil to effect signal offset compensation (namely, coil area reduction of the second lobe of the sine coil). Reference numbers of apparatus 700 of FIG. 7 that match those of apparatus 100 indicate the same or similar elements as apparatus 100, and the one or more examples and/or variations described in relation to apparatus 100 apply to apparatus 700 of FIG. 7 as well.

Apparatus 700 comprises a support structure 102 and multiple coils 704 on, or in, support structure 102. Multiple coils 704 include one or more oscillator coils 110, a first sense coil comprising a sine coil 712, and a second sense coil comprising cosine coil 114.

The target is movably positionable along a longitudinal axis of support structure 102 from a start position 720 (at or near first end 202 of support structure 102) to an end position 730 (at or near second end 204 of support structure 102). In one or more examples, the target 105 is movably positioned along the longitudinal axis in a direction 707 (e.g., left to right movement) (e.g., away from the coupling of multiple coils 704 to position sensor circuitry 118). Again, the target has a length L that is greater than or equal to a measurement range of the sensor, which extends generally from start position 720 to end position 730 of the sensor. In one or more examples, the target has a length L that is greater than or equal to the coil length, or greater than or equal to at least 90 percent of the coil length.

Sine coil 712 generally forms a sine wave pattern and defines at least a first lobe 750 (e.g., a positive lobe) and a second lobe 760 (e.g., a negative lobe). Cosine coil 114 generally forms a cosine wave pattern and defines the first lobe portions substantially coextensive with first lobe 750 of sine coil 712, and second lobe portions 342 and 344 substantially coextensive with second lobe 760 of sine coil 712. In one or more examples, a coil area of second lobe 760 of sine coil 712 is reduced to compensate for the signal offset. In one or more examples, second lobe 760 (the negative lobe) having the reduced coil area is located at first end 202 of support structure 102 at or towards end position 730 for the target.

More particularly, in one or more examples, a coil area of second lobe 760 of sine coil 712 is less than a coil area of second lobe portions 342 and 342 of cosine coil 114. In one or more examples, the coil area of second lobe 760 of sine coil 712 is less than the coil area of second lobe portions 342 and 344 of cosine coil 114 by a percentage difference, where the percentage difference of second lobe 760 is sufficient to cancel or compensate for the signal offset. In one or more examples, the percentage difference is within a range of about 20 to 30 percent, without limitation. In one or more examples, the coil area of second lobe 760 of sine coil 712 is less than the coil area of second lobe portions 342 and 344 of cosine coil 114 by about 25 percent, without limitation.

In the specific, non-limiting example of FIG. 7, the lobe area reduction for signal offset compensation is achieved by reducing the number of coil winding portions of second lobe 760 of sine coil 712, similar to apparatus 100 of FIGS. 1A, 1B, 2, 3A-3C, and 4; see coil winding portions 762 and 764 of FIG. 7 which are reduced in number, with use of a bypass connection (e.g., see bypass connection 410 of FIG. 4).

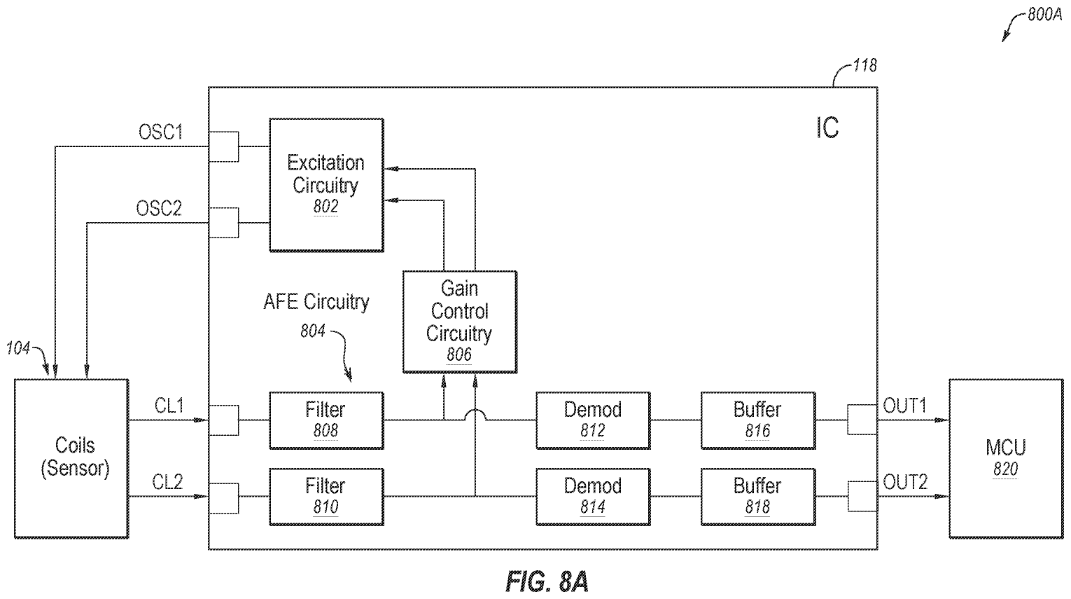

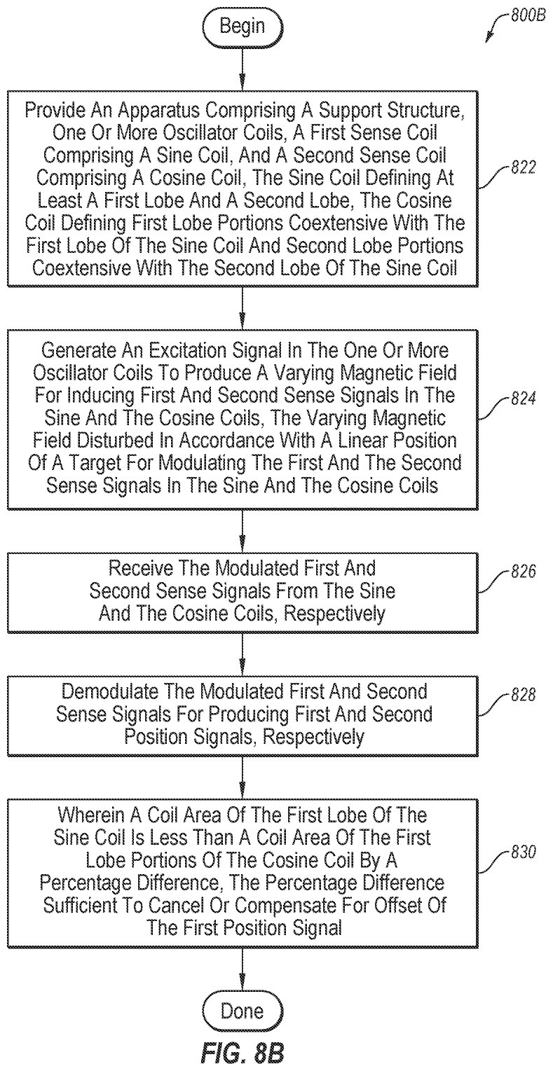

FIG. 8A is a schematic diagram 800A of position sensor circuitry 118 of a linear position according to one or more examples. In one or more examples, position sensor circuitry 118 may be contained (in total or in part) in an IC. In one or more examples, position sensor circuitry 118 includes an excitation circuitry 802, an analog front-end (AFE) circuitry 804, and a gain control circuitry 806. AFE circuitry 804 may include, for a modulated first sense signal from the sine coil (at input CL1), a filter 808 (e.g., an EMI filter), a demodulator 812, and a buffer 816. AFE circuitry 804 may also include, for a modulated second sense signal from the cosine coil (at input CL2), a filter 810 (e.g., an EMI filter), a demodulator 814, and a buffer 818. First and second position signals (e.g., indicating a position of the target) may be provided at outputs OUT1 and OUT2 of position sensor circuitry 118. Gain control circuitry 806 may be coupled to the signal paths (e.g., prior to signal demodulation) and to excitation circuitry 802. Gain control circuitry 806 may be provided to adjust the amplitude of excitation signals from excitation circuitry 802 responsive to changes in the received sense signals (e.g., adjustments based on an airgap variation between the target and the coils).

In general, the first and the second position signals are determined at least partially based on the modulated first and the second sense signals from the sine and the cosine coils (e.g., CL1, CL2), respectively. More specifically, excitation circuitry 802 is to generate one or more excitation signals in the one or more oscillator coils (e.g., at OSC1, OSC2) to produce a varying magnetic field for inducing the first and the second sense signals in the sine and cosine coils, respectively. The varying magnetic field is disturbed in accordance with a linear position of the target for modulating the first and the second sense signals in the sine and the cosine coils. The modulated first and second sense signals are received from the sine and the cosine coils at inputs (e.g., CL1, CL2). AFE circuitry 804 receives and processes these signals. The modulated first sense signal (at CL1) is filtered through filter 808, demodulated by demodulator 812 to produce the first position signal, and outputted to the output OUT1 through buffer 816. The modulated second sense signal from the cosine coil (at CL2) is filtered through filter 810, demodulated by demodulator 814 to produce the second position signal, and outputted to the output OUT2 through buffer 818.

In one or more examples, when position sensor circuitry 118 includes a processor (e.g., a central processing unit (CPU)), position sensor circuitry 118 may also calculate the linear position of the target at least partially based on the first and the second positions signals (e.g., based on an arctan2 function). In one or more other examples, a microcontroller unit (MCU) 820 or an electronic control unit (ECU) may receive the first and the second positions signals at the outputs OUT1 and OUT 2, respectively, and calculate the linear position of the target at least partially based on the first and the second positions signals (e.g., based on an arctan2 function).

In one or more examples, the one or more oscillator coils include a first oscillator coil and a second oscillator coil, and excitation circuitry 802 is to generate a first excitation signal in the first oscillator coil and a second excitation signal in the second oscillator coil, for producing the varying magnetic field for inducing first and second sense signals in the sine and the cosine coils, respectively. In one or more examples, the second excitation signal is substantially 180° out-of-phase with the first excitation signal.

FIG. 8B is a flowchart describing a method 800B of operating an apparatus comprising a linear inductive position sensor, according to one or more examples. At an act 822 of FIG. 8B, an apparatus is provided. The apparatus comprises a support structure, the one or more oscillator coils, a first sense coil comprising a sine coil, and a second sense coil comprising a cosine coil. The sine coil defines at least a first lobe and a second lobe. The cosine coil defines first lobe portions substantially coextensive with the first lobe of the sine coil and second lobe portions substantially coextensive with the second lobe of the sine coil.

At acts 824, 826, and 828 of FIG. 8B, first and second position signals indicating a position of a target are determined at least partially based on first and second sense signals from the sine and the cosine coils, respectively. More specifically, at an act 824, an excitation signal in the one or more oscillator coils is generated to produce a varying magnetic field for inducing the first and the second sense signals in the sine and cosine coils, respectively. The varying magnetic field is disturbed in accordance with a linear position of the target for modulating the first and the second sense signals in the sine and the cosine coils. At an act 826, the modulated first and second sense signals are received from the sine and the cosine coils, respectively. At an act 828, the modulated first and second sense signals are demodulated to produce the first and the second position signals, respectively.

As described at a block 830 of FIG. 8B, a coil area of the first lobe of the sine coil is less than a coil area of the first lobe portions of the cosine coil by a percentage difference, where the percentage difference of the first lobe is sufficient to cancel or compensate for an offset of the first position signal. In one or more examples, the percentage difference within a range of about 20 to 30 percent. In one or more examples, the percentage difference is about 25 percent.

In one or more examples, a position voltage of the target is determined based on the first and the second position signals (e.g., calculated based on an arctan2 function of the ratio of the signals). The position voltage may exhibit an improved linearity over the measurement range from the start position to the end position.

In one or more examples of method 800B of FIG. 8B, the target has a length that is greater than or equal to a measurement range extending substantially between opposing ends of the sine or the cosine coil. The target is movably positionable along the longitudinal axis of the support structure from a start position to an end position. In the start position, the target is to disturb substantially little or none of a magnetic coupling between the one or more oscillator coils and the sine and the cosine coils. In a middle position, the target is to disturb substantially an entire half of the magnetic coupling between the one or more oscillator coils and the sine and the cosine coils. In the end position, the target is to disturb substantially most or an entirety of the magnetic coupling between the one or more oscillator coils and the sine and the cosine coils. For offset compensation, the first lobe of the sine coil may be located at a first end of the support structure at or towards the end position for the target.

FIG. 9 is a graph 900 of output voltages of the sine and cosine coils versus target position for a linear inductive position sensor, without optimization of the disclosure (e.g., without lobe area reduction of the sine coil). More particularly, graph 900 shows a first position signal 902 (e.g., a first output voltage) determined from a modulated first sense signal from the sine coil, and a second position signal 904 (e.g., a second output voltage) determined from a modulated second sense signal from the cosine coil. In one or more examples, first and second position signals 902 and 904 may be or be referred to as first and second differential signals. Graph 900 also shows a first reference position signal 902′ (e.g., a first reference output voltage) provided for comparison with first position signal 902, to reveal an offset between first position signal 902 and first reference position signal 902′ (i.e., the desired signal). In one or more examples, the offset is produced at least partially based on the length, size, and/or arrangement of the target relative to the sensor (e.g., see target 105 of FIGS. 1A and 1B, and target or movable part 605 of FIGS. 6A and 6B).

FIG. 10 is a graph 1000 of analog output voltage versus target position for a linear inductive position sensor, without optimization of the disclosure (e.g., without lobe area reduction of the sine coil). More particularly, a position voltage 1002 in graph 1000 is calculated based on the first and second position signals (e.g., the first and second positions signals 902 and 904 of FIG. 9) determined from the modulated first and second sense signals from the sine and the cosine coils, respectively. In FIG. 10, position voltage 1002 is shown to be substantially linear over a portion of the varying position of the target (e.g., from a start position at 0 mm to about 50 mm), but includes a substantial non-linear portion 1004 or drop toward an end position of the target (e.g., from about 50 mm to about 72 mm). As is apparent, the determination or calculation of the position of the target will fail (e.g., resulting in position inaccuracy) toward the end position of the target without use of any optimization.

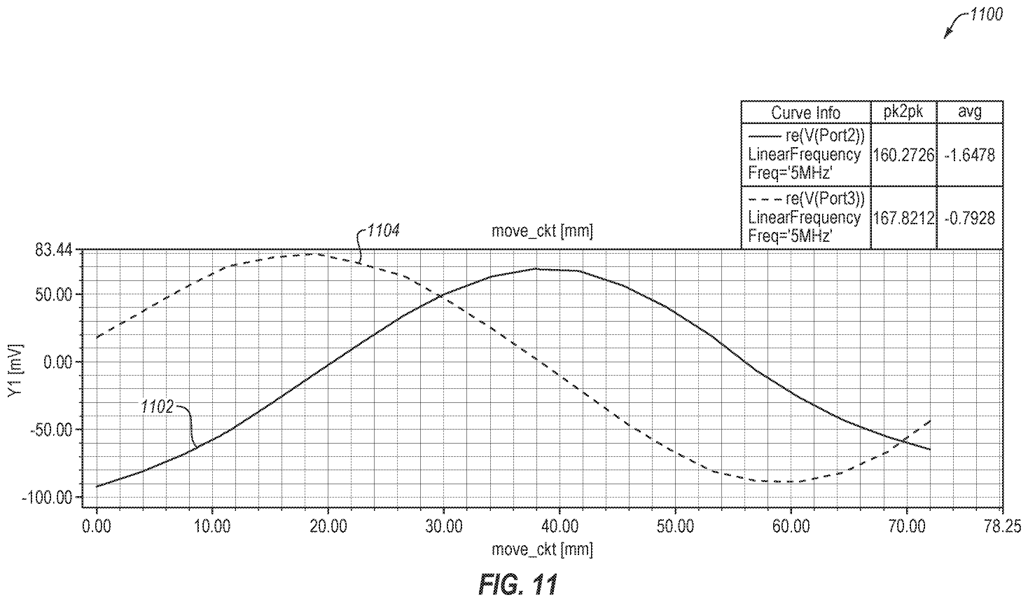

FIG. 11 is a graph 1100 of output voltages of the sine and cosine coils versus target position for a linear inductive position sensor, according to one or more examples of the disclosure. More particularly, graph 1100 shows a first position signal 1102 (e.g., a first output voltage) determined from a modulated first sense signal from the sine coil, and a second position signal 1104 (e.g., a second output voltage) determined from a modulated second sense signal from the cosine coil. In one or more examples, first and second position signals 1102 and 1104 may be or be referred to as first and second differential signals. Comparing first position signal 1102 of FIG. 11 (with optimization) with first position signal 902 of FIG. 9 (without optimization), it is apparent that the offset is reduced, canceled, or compensated, according to one or more examples of the disclosure.

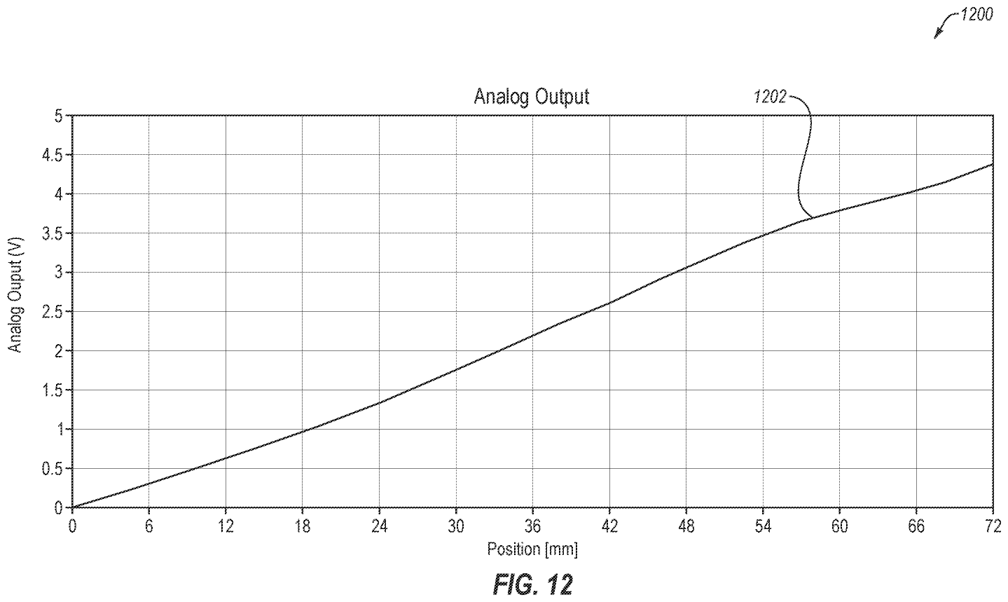

FIG. 12 is a graph 1200 of analog output voltage versus target position for a linear inductive position sensor, according to one or more examples of the disclosure. More particularly, a position voltage 1202 in graph 1200 is calculated based on the first and second position signals (e.g., the first and second position signals 1102 and 1104 of FIG. 11) which are determined from the modulated first and second sense signals from the sine and the cosine coils, respectively. In FIG. 12, position voltage 1202 is shown to be substantially linear over substantially the entire varying position of the target (e.g., from a start position at 0 mm to about 72 mm). In one or more examples, position voltage 1202 excludes any substantial non-linear portion or drop at or near the end position of the target (e.g., compare with substantial non-linear portion 1004 in position voltage 1002 of FIG. 10). As is apparent, the determination or calculation of the position of the target will remain accurate over substantially the entire measurement range, including at or near the end position of the target, according to one or more examples of the disclosure.

As described earlier, lobe area reduction for offset compensation may be achieved in a number of different ways. According to one or more examples, lobe area reduction for offset compensation may be achieved by reducing widths of coil windings of the lobe, and/or reducing sizes/heights of the lobe, as now described in relation to FIGS. 13A, 13B, 14A, and 14B.

FIGS. 13A and 13B are top-down views of sine and cosine coils 1300A and 1300B, respectively, of a linear inductive position sensor according to one or more examples. Although shown in separate figures, sine and cosine coils 1300A and 1300B may be provided together on, or in, a support structure with the one or more oscillator coils, in the same or similar manner as in FIGS. 1A, 1B, 2, and 3A-3C.

In FIGS. 13A and 13B, lobe area reduction for signal offset compensation is achieved by reducing a width of one or more coil winding portions of the sine coil. In FIG. 13A, sine coil 1300A defines at least a first lobe 1310 (e.g., a positive lobe) and a second lobe 1320 (e.g., a negative lobe). First lobe 1310 of sine coil 1300A may include first lobe portions 1312 and 1314, and second lobe 1320 of sine coil 1300A may include second lobe portions 1322 and 1324. In FIG. 13B, cosine coil 1300B defines first lobe portions 1332 and 1334 (e.g., first half lobes) substantially coextensive with first lobe 1310 of sine coil 1300A, and second lobe portions 1342 and 1344 (e.g., second half lobes) substantially coextensive with second lobe 1320 of sine coil 1300A. A lobe 1350 (e.g., negative lobe) in a middle of cosine coil 1300B is defined by first lobe portion 1334 and second lobe portion 1342.

In a typical configuration, a sine coil may include a first lobe having one or more first coil winding portions having a width W₁ and a second lobe having one or more second coil winding portions having a width W₂; and a cosine coil may include first lobe portions having one or more first coil winding portions having widths W₁ and second lobe portions having one or more second coil winding portions having widths W₂, where W₁=W₂. With all other features being equal, the lobes and the lobe portions of the sine and cosine coils would have the same sizes and coil areas.

In one or more examples of FIGS. 13A and 13B, first lobe 1310 of sine coil 1300A has one or more first coil winding portions having a width W_{1R}, second lobe 1320 of sine coil 1300A has one or more second coil winding portions having a width W₂, first lobe portions 1332 and 1334 of cosine coil 1300B has one or more first coil winding portions having respective widths W₁, and second lobe portions 1342 and 1344 of cosine coil 1300B has one or more second coil winding portions having respective widths W₂, where W_{1R}<W₁=W₂. Notably, the width of the one or more first coil winding portions of first lobe 1310 of sine coil 1300A (i.e., W_{1R}) is less than the width of one or more first coil winding portions of first lobe portions 1332 and 1334 of cosine coil 1300B (i.e., W₁). The difference in widths of W_{1R} and W₁ of the coil winding portions results in the coil area of first lobe 1310 of sine coil 1300A to be less than the coil area of first lobe portions 1332 and 1334 of cosine coil 1300B by a percentage difference. In one or more examples, the percentage difference of first lobe 1310 is sufficient to cancel or compensate for an offset of a position signal. In one or more examples, the percentage difference sufficient to cancel or compensate for the offset is within a range of about 20 to 30 percent (e.g., about 25 percent).

In a specific, non-limiting example of FIGS. 13A and 13B, first lobe portion 1312 of first lobe 1310 has the one or more first coil winding portions having the width W_{1R} and first lobe portion 1314 of first lobe 1310 has the one or more second coil winding portions having the width W₁, where the widths W₁ of first lobe portion 1314 of first lobe 1310 of sine coil 1300A and first lobe portion 1334 of cosine coil 1300B are the same, resulting in a percentage difference of the area of first lobe 1310 to be sufficient to cancel or compensate for an offset of a position signal. Giving more detail, the coil area of first lobe 1310 of sine coil 1300A is defined by a first coil area of first lobe portion 1312 (e.g., a first half lobe) and a second coil area of first lobe portion 1314 (e.g., a second half lobe). First lobe portions 1332 and 1334 of cosine coil 1300B include first lobe portion 1332 (e.g., a first half lobe) substantially coextensive with first lobe portion 1312 (e.g., the first half lobe) of sine coil 1300A, and first lobe portion 1334 (e.g., the second half lobe) substantially coextensive with first lobe portion 1314 (e.g., the second half lobe) of sine coil 1300A. The coil area of first lobe portions 1332 and 1334 of cosine coil 1300B is defined by a first coil area of first lobe portion 1332 (e.g., the first half lobe) and a second coil area of the first lobe portion 1334 (e.g., the second half lobe).

Here, the first coil area of first lobe portion 1312 of sine coil 1300A is less than the first coil area of first lobe portion 1332 of cosine coil 1300B by a percentage difference, where the percentage difference is between about 40 and 60 percent (e.g., about 50 percent). On the other hand, the second coil area of first lobe portion 1314 of sine coil 1300A is substantially the same as the second coil area of first lobe portion 1334 of cosine coil 1300B. The percentage difference of between about 40 and 60 percent results in the coil area of first lobe 1310 of sine coil 1400A to be less than the coil area of first lobe portions 1332 and 1334 of cosine coil 1300B by a percentage difference that is sufficient to cancel or compensate for an offset of a position signal. In one or more examples, the percentage difference of first lobe 1310 is sufficient to cancel or compensate for the offset is within a range of about 20 to 30 percent (e.g., about 25 percent).

FIGS. 14A and 14B are top-down views of sine and cosine coils 1400A and 1400B, respectively, of a linear inductive position sensor according to one or more examples. Although shown in separate figures, sine and cosine coils 1400A and 1400B may be provided together on, or in, a support structure with the one or more oscillator coils, in the same or similar manner as in FIGS. 1A, 1B, 2, and 3A-3C.

In FIGS. 14A and 14B, lobe area reduction for signal offset compensation is achieved by reducing a maximum height or size of the first lobe of the sine coil. In FIG. 14A, sine coil 1400A defines at least a first lobe 1410 (e.g., a positive lobe) and a second lobe 1420 (e.g., a negative lobe). In FIG. 14B, cosine coil 1400B defines first lobe portions 1432 and 1434 (e.g., first half lobes) substantially coextensive with first lobe 1410 of sine coil 1400A, and second lobe portions 1442 and 1444 (e.g., second half lobes) substantially coextensive with second lobe 1420 of sine coil 1400A. A lobe 1450 in a middle of cosine coil 1400B is defined by first lobe portion 1434 and second lobe portion 1442.

In a typical configuration, a sine coil may include a first lobe having a maximum height of H₁and a second lobe having a maximum height of H₂; and a cosine coil may include first lobe portions having respective maximum heights of H₁ and second lobe portions having respective maximum heights of H₂, where H₁=H₂. With all other features being equal, the lobes and the lobe portions of the sine and cosine coils would have the same sizes and coil areas.

In one or more examples of FIGS. 14A and 14B, first lobe 1410 of sine coil 1400A has a maximum height of H_{1R}, second lobe 1420 of sine coil 1400A has a maximum height of H₂, first lobe portions 1432 and 1434 have respective maximum heights of H₁, and second lobe portions have respective maximum heights of H₂, where H_{1R}<H₁=H₂. Notably, the maximum height or size of first lobe 1410 of sine coil 1400A (i.e., H_{1R}) is less than a maximum height or size of first lobe portions 1432 and 1434 of cosine coil 1400B (i.e., H₁).

The difference in maximum heights of H_{1R}and H₁ (or more generally, the lobe sizes) of the lobe and lobe portions results in the coil area of first lobe 1410 of sine coil 1400A to be less than the coil area of first lobe portions 1432 and 1434 of cosine coil 1400B by a percentage difference. In one or more examples, the percentage difference of first lobe 1410 is sufficient to cancel or compensate for an offset of a position signal. In one or more examples, the percentage difference sufficient to cancel or compensate for the offset is within a range of about 20 to 30 percent (e.g., about 25 percent).

In one or more examples described herein, the coils may be formed with a single turn from end to end. In other various examples, the coils may be formed with substantially two turns from end to end, and even formed with more than two turns, without exceeding the scope of this disclosure.

Various examples disclosed herein have many advantages over previous solutions. The present disclosure relates to a non-contacting planar linear inductive sensor for measuring the position of a movable target. In some implementations, the proposed sensor is configured for use in clutch applications as well as linear actuation applications. With the proposed sensor design, customers can use the sensor for increased linearity, measurement range, mechanical resolution, and accuracy.

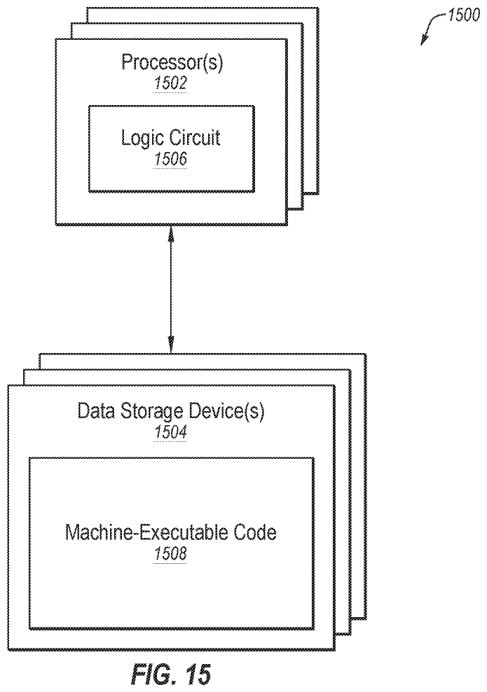

FIG. 15 is a block diagram of circuitry 1500 that, in some examples, may be used to implement various functions, operations, acts, processes, and/or methods disclosed herein. The circuitry 1500 includes one or more processors 1502 (sometimes referred to herein as “processors 1502”) operably coupled to one or more data storage devices (sometimes referred to herein as “storage 1504”). The storage 1504 includes machine-executable code 1508 stored thereon and the processors 1502 include a logic circuit 1506. The machine-executable code 1508 includes information describing functional elements that may be implemented by (e.g., performed by) the logic circuit 1506. The logic circuit 1506 is adapted to implement (e.g., perform) the functional elements described by the machine-executable code 1508. The circuitry 1500, when executing the functional elements described by the machine-executable code 1508, should be considered as special purpose hardware for carrying out functional elements disclosed herein. In some examples, the processors 1502 may perform the functional elements described by the machine-executable code 1508 sequentially, concurrently (e.g., on one or more different hardware platforms), or in one or more parallel process streams.

When implemented by logic circuit 1506 of the processors 1502, the machine-executable code 1508 adapts the processors 1502 to perform operations of examples disclosed herein. For example, the machine-executable code 1508 may be to adapt the processors 1502 to perform at least a portion or a totality of operations associated with the apparatus 100 for inductive linear-position sensing according to one or more examples, including acts in a method of operating a linear inductive position sensor (e.g., method 800B of FIG. 8B).

The processors 1502 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 1508 (e.g., software code, firmware code, hardware descriptions) related to examples of the present disclosure. It is noted that a general-purpose processor (may also be referred to herein as a host processor or simply a host) may be a microprocessor, but in the alternative, the processors 1502 may include any conventional processor, controller, microcontroller, or state machine. The processors 1502 may also be implemented as a combination of computing devices, such as a combination of a DSP and a microprocessor, a plurality of microprocessors, one or more microprocessors in conjunction with a DSP core, or any other such configuration.

In some examples the storage 1504 includes volatile data storage (e.g., random-access memory (RAM)), non-volatile data storage (e.g., Flash memory, a hard disc drive, a solid-state drive, erasable programmable read-only memory (EPROM), etc.). In some examples the processors 1502 and the storage 1504 may be implemented into a single device (e.g., a semiconductor device product, a system on chip (SOC), etc.). In some examples the processors 1502 and the storage 1504 may be implemented into separate devices.

In some examples the machine-executable code 1508 may include computer-readable instructions (e.g., software code, firmware code). By way of non-limiting example, the computer-readable instructions may be stored by the storage 1504, accessed directly by the processors 1502, and executed by the processors 1502 using at least the logic circuit 1506. Also by way of non-limiting example, the computer-readable instructions may be stored on the storage 1504, transferred to a memory device (not shown) for execution, and executed by the processors 1502 using at least the logic circuit 1506. Accordingly, in some examples the logic circuit 1506 includes electrically configurable logic circuit 1506.

In some examples the machine-executable code 1508 may describe hardware (e.g., circuitry) to be implemented in the logic circuit 1506 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large-scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 1506 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1508 may include an HDL, an RTL, a GL description, a mask level description, other hardware description, or any combination thereof.

In examples where the machine-executable code 1508 includes a hardware description (at any level of abstraction), a system (not shown, but including the storage 1504) may be to implement the hardware description described by the machine-executable code 1508. By way of non-limiting example, the processors 1502 may include a programmable logic device (e.g., an FPGA or a PLC) and the logic circuit 1506 may be electrically controlled to implement circuitry corresponding to the hardware description into the logic circuit 1506. Also by way of non-limiting example, the logic circuit 1506 may include hard-wired logic manufactured by a manufacturing system (not shown, but including the storage 1504) according to the hardware description of the machine-executable code 1508.

Regardless of whether the machine-executable code 1508 includes computer-readable instructions or a hardware description, the logic circuit 1506 is adapted to perform the functional elements described by the machine-executable code 1508 when implementing the functional elements of the machine-executable code 1508. It is noted that although a hardware description may not directly describe functional elements, a hardware description indirectly describes functional elements that the hardware elements described by the hardware description are capable of performing.

As used in the present disclosure, references to things (including oscillator coils, sense coils, and paths, without limitation) being “at,” “in,” “on,” “arranged at,” “arranged in,” “arranged on” and like terms a support structure may refer to the things being arranged substantially within and/or on a surface of the support structure.

In addition, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

Further, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples of the disclosure include:

Example 1: An apparatus comprising: a support structure; a first sense coil comprising a sine coil arranged about a longitudinal axis of the support structure, the sine coil having opposing ends between opposing ends of the support structure, the sine coil defining at least a first lobe and a second lobe; a second sense coil comprising a cosine coil arranged about the longitudinal axis of the support structure, the cosine coil having opposing ends between the opposing ends of the support structure, the cosine coil defining first lobe portions substantially coextensive with the first lobe of the sine coil and second lobe portions substantially coextensive with the second lobe of the sine coil; and one or more oscillator coils arranged around the sine coil and the cosine coil, wherein a coil area of the first lobe of the sine coil is less than a coil area of the first lobe portions of the cosine coil.

Example 2: The apparatus according to Example 1, wherein the coil area of the first lobe of the sine coil is less than the coil area of the first lobe portions of the cosine coil by a percentage difference, the percentage difference within a range of about 20 to 30 percent.

Example 3: The apparatus according to any of Examples 1 and 2, wherein the coil area of the first lobe of the sine coil is less than the coil area of the first lobe portions of the cosine coil by about 25 percent.

Example 4: The apparatus according to any of Examples 1 through 3, wherein the first lobe portions of the cosine coil comprise first half lobes and the second lobe portions of the cosine coil comprise second half lobes.

Example 5: The apparatus according to any of Examples 1 through 4, comprising: a target movably positionable along the longitudinal axis of the support structure between a start position and an end position, wherein the first lobe is located at an end of the support structure at or towards the end position for the target.

Example 6: The apparatus according to any of Examples 1 through 5, wherein: the first lobe of the sine coil comprises a first number of one or more first coil winding portions, the first lobe portions of the cosine coil comprise a second number of one or more second coil winding portions, and the first number of the one or more first coil winding portions is less than the second number of the one or more second coil winding portions.

Example 7: The apparatus according to any of Examples 1 through 6, wherein the sine coil comprises: a first coil turn; a second coil turn; and a bypass connection to connect an end of the first coil turn to a beginning of the second coil turn at substantially a middle of the first lobe.

Example 8: The apparatus according to any of Examples 1 through 7, wherein: the first lobe of the sine coil includes a first half lobe and a second half lobe, the coil area of the first lobe of the sine coil is defined by a first coil area of the first half lobe and a second coil area of the second half lobe, the first lobe portions of the cosine coil include a first half lobe substantially coextensive with the first half lobe of the sine coil and a second half lobe substantially coextensive with the second half lobe of the sine coil, the coil area of the first lobe portions of the cosine coil is defined by a first coil area of the first half lobe and a second coil area of the second half lobe, the first coil area of the first half lobe of the sine coil is less than the first coil area of the first half lobe of the cosine coil by a percentage difference, the percentage difference between about 40 and 60 percent, and the second coil area of the second half lobe of the sine coil is substantially the same as the second coil area of the second half lobe of the cosine coil.

Example 9: The apparatus according to any of Examples 1 through 8, wherein a width of one or more first coil winding portions of the first lobe of the sine coil is less than a width of one or more second coil winding portions of the first lobe portions of the cosine coil.

Example 10: The apparatus according to any of Examples 1 through 9, wherein a maximum height or size of the first lobe of the sine coil is less than a maximum height or size of the first lobe portions of the cosine coil.

Example 11: The apparatus according to any of Examples 1 through 10, comprising: a position sensor circuitry to determine first and second position signals indicating a position of a target at least partially based on first and second sense signals from the sine coil and the cosine coil, respectively, wherein the coil area of the first lobe of the sine coil is less than the coil area of the first lobe portions of the cosine coil by a percentage difference, the percentage difference of the first lobe being sufficient to cancel or compensate for an offset of the first position signal.

Example 12: The apparatus according to any of Examples 1 through 11, comprising: a target movably positionable along the longitudinal axis of the support structure between a start position and an end position, the target having a length greater than or equal to a measurement range extending substantially between the opposing ends of the sine coil or the cosine coil, wherein in the start position, the target is to disturb substantially little or none of a magnetic coupling between the one or more oscillator coils and the sine coil and the cosine coil, and wherein in the end position, the target is to disturb substantially most or an entirety of the magnetic coupling between the one or more oscillator coils and the sine coil and the cosine coil, and wherein the first lobe of the sine coil is located at an end of the support structure at or towards the end position for the target.

Example 13: The apparatus according to any of Examples 1 through 12, wherein: the position sensor circuitry is to determine a position voltage of the target based on the first and the second position signals, the position voltage having improved linearity over the measurement range from the start position to the end position as a result of the coil area of the first lobe of the sine coil being less than the coil area of the first lobe portions of the cosine coil by the percentage difference.

Example 14: A method comprising: providing an apparatus comprising a support structure, one or more oscillator coils, a first sense coil, and a second sense coil, the first sense coil comprising a sine coil arranged about a longitudinal axis of the support structure, the sine coil having opposing ends between opposing ends of the support structure, the sine coil defining at least a first lobe and a second lobe, the second sense coil comprising a cosine coil arranged about the longitudinal axis of the support structure, the cosine coil having opposing ends between the opposing ends of the support structure, the cosine coil defining first lobe portions substantially coextensive with the first lobe of the sine coil and second lobe portions substantially coextensive with the second lobe of the sine coil, the one or more oscillator coils arranged around the sine coil and the cosine coil; and determining first and second position signals indicating a position of a target at least partially based on first and second sense signals from the sine coil and the cosine coil, respectively, wherein a coil area of the first lobe of the sine coil is less than a coil area of the first lobe portions of the cosine coil by a percentage difference, the percentage difference of the first lobe being sufficient to cancel or compensate for an offset of the first position signal.

Example 15: The method according to Example 14, wherein the target is movably positionable along the longitudinal axis of the support structure from a start position to an end position, the target has a length that is greater than or equal to a measurement range extending substantially between the opposing ends of the sine coil or the cosine coil, and the first lobe of the sine coil is located at an end of the support structure at or towards the end position for the target.

Example 16: The method according to any of Examples 14 and 15, wherein in the start position, the target is to disturb substantially little or none of a magnetic coupling between the one or more oscillator coils and the sine coil and the cosine coil, and wherein in the end position, the target is to disturb substantially most or an entirety of the magnetic coupling between the one or more oscillator coils and the sine coil and the cosine coil.

Example 17: The method according to any of Examples 14 through 16, wherein the percentage difference within a range of about 20 to 30 percent.

Example 18: The method according to any of Examples 14 through 17, wherein the percentage difference is about 25 percent.

Example 19: The method according to any of Examples 14 through 18, wherein the determining comprises: generating an excitation signal in the one or more oscillator coils to produce a varying magnetic field for inducing the first and the second sense signals in the sine coil and the cosine coil, respectively, the varying magnetic field disturbed in accordance with a linear position of the target for modulating the first and the second sense signals in the sine coil and the cosine coil; receiving the modulated first and second sense signals from the sine coil and the cosine coil, respectively; and demodulating the modulated first and second sense signals to produce the first and the second position signals, respectively.

Example 20: An apparatus comprising: a linear inductive position sensor comprising: a support structure; a first sense coil comprising a sine coil arranged about a longitudinal axis of the support structure, the sine coil having opposing ends between opposing ends of the support structure, the sine coil defining at least a first lobe and a second lobe; a second sense coil comprising a cosine coil arranged about the longitudinal axis of the support structure, the cosine coil having opposing ends between the opposing ends of the support structure, the cosine coil defining first lobe portions substantially coextensive with the first lobe of the sine coil and second lobe portions substantially coextensive with the second lobe of the sine coil; one or more oscillator coils arranged around the sine coil and the cosine coil; a target movably positionable along the longitudinal axis from a start position to an end position, the target having a length that is greater than or equal to a measurement range extending substantially between the opposing ends of the sine coil or the cosine coil; and a position sensor circuitry to determine a first position signal and a second position signal indicating a position of the target at least partially based on first and second sense signals from the sine coil and the cosine coil, respectively, wherein the first lobe of the sine coil is located at an end of the support structure at or towards the end position for the target, and wherein a coil area of the first lobe of the sine coil is less than a coil area of the first lobe portions of the cosine coil by a percentage difference, the percentage difference of the first lobe being sufficient to cancel or compensate for an offset of the first position signal.

Example 21: The apparatus according to Example 20, wherein the percentage difference is within a range of about 20 to 30 percent.

Example 22: The apparatus according to any of Examples 20 and 21, wherein the percentage difference is about 25 percent.

Example 23: The apparatus according to any of Examples 20 through 22, wherein in a start position, the target is to disturb substantially little or none of a magnetic coupling between the one or more oscillator coils and the sine coil and the cosine coil, and wherein in an end position, the target is to disturb substantially most or an entirety of the magnetic coupling between the one or more oscillator coils and the sine coil and the cosine coil.

Example 24: The apparatus according to any of Examples 20 through 23, wherein: the position sensor circuitry is to determine a position voltage of the target based on the first position signal and the second position signal, the position voltage having improved linearity over the measurement range from the start position to the end position as a result of the coil area of the first lobe of the sine coil being less than the coil area of the first lobe portions of the cosine coil by the percentage difference.

Example 25: An apparatus comprising: a support structure; a first sense coil comprising a sine coil arranged about a longitudinal axis of the support structure, the sine coil having opposing ends between opposing ends of the support structure; a second sense coil comprising a cosine coil arranged about the longitudinal axis of the support structure, the cosine coil having opposing ends between the opposing ends of the support structure; and one or more oscillator coils arranged around the sine coil and the cosine coil, wherein a coil area of a first lobe of the sine coil is less than a coil area of a second lobe of the sine coil by a percentage difference, the percentage difference within a range of about 20 to 30 percent.

Example 26: The apparatus according to Example 25, wherein the coil area of the first lobe of the sine coil is less than the coil area of the second lobe of the sine coil by about 25 percent.

Example 27: The apparatus according to any of Examples 25 and 26, comprising: a position sensor circuitry to determine a first position signal and a second position signal indicating a position of a target at least partially based on first and second sense signals from the sine coil and the cosine coil, respectively, wherein the target is movably positionable along the longitudinal axis from a start position to an end position, and has a length that is greater than or equal to a measurement range extending substantially between the opposing ends of the sine coil or the cosine coil, wherein the first lobe of the sine coil is located at an end of the support structure at or towards the end position for the target.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
a support structure;
a first sense coil comprising a sine coil arranged about a longitudinal axis of the support structure, the sine coil having opposing ends between opposing ends of the support structure, the sine coil defining at least a first lobe and a second lobe;
a second sense coil comprising a cosine coil arranged about the longitudinal axis of the support structure, the cosine coil having opposing ends between the opposing ends of the support structure, the cosine coil defining first lobe portions substantially coextensive with the first lobe of the sine coil and second lobe portions substantially coextensive with the second lobe of the sine coil; and
one or more oscillator coils arranged around the sine coil and the cosine coil,
wherein a coil area of the first lobe of the sine coil is less than a coil area of the first lobe portions of the cosine coil.

2. The apparatus of claim 1, wherein the coil area of the first lobe of the sine coil is less than the coil area of the first lobe portions of the cosine coil by a percentage difference, the percentage difference within a range of about 20 to 30 percent.

3. The apparatus of claim 1, wherein the coil area of the first lobe of the sine coil is less than the coil area of the first lobe portions of the cosine coil by about 25 percent.

4. The apparatus of claim 1, wherein the first lobe portions of the cosine coil comprise first half lobes and the second lobe portions of the cosine coil comprise second half lobes.

5. The apparatus of claim 1, comprising:
a target movably positionable along the longitudinal axis of the support structure between a start position and an end position,
wherein the first lobe is located at an end of the support structure at or towards the end position for the target.

6. The apparatus of claim 1, wherein:
the first lobe of the sine coil comprises a first number of one or more first coil winding portions,
the first lobe portions of the cosine coil comprise a second number of one or more second coil winding portions, and
the first number of the one or more first coil winding portions is less than the second number of the one or more second coil winding portions.

7. The apparatus of claim 1, wherein the sine coil comprises:
a first coil turn;
a second coil turn; and
a bypass connection to connect an end of the first coil turn to a beginning of the second coil turn at substantially a middle of the first lobe.

8. The apparatus of claim 1, wherein:
the first lobe of the sine coil includes a first half lobe and a second half lobe,
the coil area of the first lobe of the sine coil is defined by a first coil area of the first half lobe and a second coil area of the second half lobe,
the first lobe portions of the cosine coil include a first half lobe substantially coextensive with the first half lobe of the sine coil and a second half lobe substantially coextensive with the second half lobe of the sine coil,
the coil area of the first lobe portions of the cosine coil is defined by a first coil area of the first half lobe and a second coil area of the second half lobe,
the first coil area of the first half lobe of the sine coil is less than the first coil area of the first half lobe of the cosine coil by a percentage difference, the percentage difference between about 40 and 60 percent, and
the second coil area of the second half lobe of the sine coil is substantially the same as the second coil area of the second half lobe of the cosine coil.

9. The apparatus of claim 1, wherein a width of one or more first coil winding portions of the first lobe of the sine coil is less than a width of one or more second coil winding portions of the first lobe portions of the cosine coil.

10. The apparatus of claim 1, wherein a maximum height or size of the first lobe of the sine coil is less than a maximum height or size of the first lobe portions of the cosine coil.

11. The apparatus of claim 1, comprising:
a position sensor circuitry to determine first and second position signals indicating a position of a target at least partially based on first and second sense signals from the sine coil and the cosine coil, respectively,
wherein the coil area of the first lobe of the sine coil is less than the coil area of the first lobe portions of the cosine coil by a percentage difference, the percentage difference of the first lobe being sufficient to cancel or compensate for an offset of the first position signal.

12. The apparatus of claim 11, comprising:
a target movably positionable along the longitudinal axis of the support structure between a start position and an end position, the target having a length greater than or equal to a measurement range extending substantially between the opposing ends of the sine coil or the cosine coil,
wherein in the start position, the target is to disturb substantially little or none of a magnetic coupling between the one or more oscillator coils and the sine coil and the cosine coil, and wherein in the end position, the target is to disturb substantially most or an entirety of the magnetic coupling between the one or more oscillator coils and the sine coil and the cosine coil, and
wherein the first lobe of the sine coil is located at an end of the support structure at or towards the end position for the target.

13. The apparatus of claim 12, wherein:
the position sensor circuitry is to determine a position voltage of the target based on the first and the second position signals, the position voltage having improved linearity over the measurement range from the start position to the end position as a result of the coil area of the first lobe of the sine coil being less than the coil area of the first lobe portions of the cosine coil by the percentage difference.

14. A method comprising:
providing an apparatus comprising a support structure, one or more oscillator coils, a first sense coil, and a second sense coil, the first sense coil comprising a sine coil arranged about a longitudinal axis of the support structure, the sine coil having opposing ends between opposing ends of the support structure, the sine coil defining at least a first lobe and a second lobe, the second sense coil comprising a cosine coil arranged about the longitudinal axis of the support structure, the cosine coil having opposing ends between the opposing ends of the support structure, the cosine coil defining first lobe portions substantially coextensive with the first lobe of the sine coil and second lobe portions substantially coextensive with the second lobe of the sine coil, the one or more oscillator coils arranged around the sine coil and the cosine coil; and
determining first and second position signals indicating a position of a target at least partially based on first and second sense signals from the sine coil and the cosine coil, respectively,
wherein a coil area of the first lobe of the sine coil is less than a coil area of the first lobe portions of the cosine coil by a percentage difference, the percentage difference of the first lobe being sufficient to cancel or compensate for an offset of the first position signal.

15. The method of claim 14, wherein the target is movably positionable along the longitudinal axis of the support structure from a start position to an end position, the target has a length that is greater than or equal to a measurement range extending substantially between the opposing ends of the sine coil or the cosine coil, and the first lobe of the sine coil is located at an end of the support structure at or towards the end position for the target.

16. The method of claim 15, wherein in the start position, the target is to disturb substantially little or none of a magnetic coupling between the one or more oscillator coils and the sine coil and the cosine coil, and wherein in the end position, the target is to disturb substantially most or an entirety of the magnetic coupling between the one or more oscillator coils and the sine coil and the cosine coil.

17. The method of claim 14, wherein the percentage difference is within a range of about 20 to 30 percent.

18. The method of claim 14, wherein the percentage difference is about 25 percent.

19. The method of claim 14, wherein the determining comprises:
generating an excitation signal in the one or more oscillator coils to produce a varying magnetic field for inducing the first and the second sense signals in the sine coil and the cosine coil, respectively, the varying magnetic field disturbed in accordance with a linear position of the target for modulating the first and the second sense signals in the sine coil and the cosine coil;
receiving the modulated first and second sense signals from the sine coil and the cosine coil, respectively; and
demodulating the modulated first and second sense signals to produce the first and the second position signals, respectively.

20. An apparatus comprising:
a linear inductive position sensor comprising:
a support structure;
a first sense coil comprising a sine coil arranged about a longitudinal axis of the support structure, the sine coil having opposing ends between opposing ends of the support structure, the sine coil defining at least a first lobe and a second lobe;
a second sense coil comprising a cosine coil arranged about the longitudinal axis of the support structure, the cosine coil having opposing ends between the opposing ends of the support structure, the cosine coil defining first lobe portions substantially coextensive with the first lobe of the sine coil and second lobe portions substantially coextensive with the second lobe of the sine coil;
one or more oscillator coils arranged around the sine coil and the cosine coil;
a target movably positionable along the longitudinal axis from a start position to an end position, the target having a length that is greater than or equal to a measurement range extending substantially between the opposing ends of the sine coil or the cosine coil; and
a position sensor circuitry to determine a first position signal and a second position signal indicating a position of the target at least partially based on first and second sense signals from the sine coil and the cosine coil, respectively,
wherein the first lobe of the sine coil is located at an end of the support structure at or towards the end position for the target, and
wherein a coil area of the first lobe of the sine coil is less than a coil area of the first lobe portions of the cosine coil by a percentage difference, the percentage difference of the first lobe being sufficient to cancel or compensate for an offset of the first position signal.

21. The apparatus of claim 20, wherein the percentage difference is within a range of about 20 to 30 percent.

22. The apparatus of claim 20, wherein the percentage difference is about 25 percent.

23. The apparatus of claim 20, wherein in a start position, the target is to disturb substantially little or none of a magnetic coupling between the one or more oscillator coils and the sine coil and the cosine coil, and wherein in an end position, the target is to disturb substantially most or an entirety of the magnetic coupling between the one or more oscillator coils and the sine coil and the cosine coil.

24. The apparatus of claim 23, wherein:
the position sensor circuitry is to determine a position voltage of the target based on the first position signal and the second position signal, the position voltage having improved linearity over the measurement range from the start position to the end position as a result of the coil area of the first lobe of the sine coil being less than the coil area of the first lobe portions of the cosine coil by the percentage difference.

25. An apparatus comprising:
a support structure;
a first sense coil comprising a sine coil arranged about a longitudinal axis of the support structure, the sine coil having opposing ends between opposing ends of the support structure;
a second sense coil comprising a cosine coil arranged about the longitudinal axis of the support structure, the cosine coil having opposing ends between the opposing ends of the support structure; and
one or more oscillator coils arranged around the sine coil and the cosine coil,
wherein a coil area of a first lobe of the sine coil is less than a coil area of a second lobe of the sine coil by a percentage difference, the percentage difference within a range of about 20 to 30 percent.

26. The apparatus of claim 25, wherein the coil area of the first lobe of the sine coil is less than the coil area of the second lobe of the sine coil by about 25 percent.

27. The apparatus of claim 25, comprising:
a position sensor circuitry to determine a first position signal and a second position signal indicating a position of a target at least partially based on first and second sense signals from the sine coil and the cosine coil, respectively, wherein the target is movably positionable along the longitudinal axis from a start position to an end position, and has a length that is greater than or equal to a measurement range extending substantially between the opposing ends of the sine coil or the cosine coil,
wherein the first lobe of the sine coil is located at an end of the support structure at or towards the end position for the target.
